(19) United States
(12) Patent Application Publication
(10) Pub. No.: US 2004/0114829 A1
(43) Pub. Date: Jun. 17, 2004

(54) Method and system for detecting and correcting defects in a digital image

(75) Inventors: Edythe Patricia LeFeuvre, St. John's (CA); Rodney D. Hale, St. John's (CA)

Correspondence Address: BERESKIN AND PARR, SCOTIA PLAZA, 40 KING STREET WEST-SUITE 4000 BOX 401, TORONTO, ON, M5H 3Y2, CA

(73) Assignee: Intelligent System Solutions Corp.

(21) Appl. No.: 10/682,364

(22) Filed: Oct. 10, 2003

Related U.S. Application Data
(60) Provisional application No. 60/505,163, filed on Sep. 24, 2003.

(30) Foreign Application Priority Data
Oct. 10, 2002 (CA) 2,405,270

(51) Int. Cl. G06K 9/40

(52) U.S. Cl. 382/275

(57) ABSTRACT

The invention relates to a method, system and computer program product for correcting a red-eye effect in a digital image provided by a cluster of pixels. It comprises (a) conducting at least one tophat operation over each pixel in the digital image to provide a tophat image; (b) conducting an intensity threshold operation on the tophat image to provide a segmentation mask for segmenting objects in the digital image; (c) for each segmented object in the segmentation mask, extracting at least one feature from at least one of the segmented object and a border region surrounding the segmented object and classifying the segmented object based on the at least one feature; and (d) for each segmented object in the segmentation mask classified as red-eye effect in step (c), correcting the red-eye effect by re-coloring the segmented object to generate a corrected image.

### FIELD OF THE INVENTION

The present invention relates generally to digital image processing, and more particularly relates to a method and system for detecting red-eye defects in a digital image.

### BACKGROUND OF THE INVENTION

A digital image is made up of the rows and columns of picture elements or “pixels”. Image size is typically expressed in terms of the number of rows and columns of pixels in an image. Pixels typically occupy a regular grid structure. A common image size is 640 columns by 480 rows (307,200 pixels total).

The color of each pixel in a color image can be described by a combination of three primary colors: Red, Green, and Blue. The color depth for each pixel specifies the number of different color levels that any pixel in the image can have. Typically color depth is expressed in terms of the number of bits of resolution used to encode color information. A common color resolution is 24 bits. At this resolution 8 bits are used to encode Red intensity, 8 bits for Green intensity and 8 bits for Blue intensity. Therefore, for each color component there are 2⁸ or 256 different intensities ranging from 0 to 255. 0 indicates an absence of a particular color and 255 indicates that that particular color has a maximum intensity at that particular pixel.

Red-eye is a common problem that occurs in photographs of people and animals taken in dimly lit places with a flash. Red-eye results when a light from the flash enters the eye and bounces off the capillaries in the back of the eye. Most flash pictures are taken in relative darkness when people's pupils are dilated. This allows light to reflect off the capillaries and return to the camera. The capillaries, which are filled with blood, produce a reflection with a red glow. Typically this happens when the flash is directly above the lens and the subject is looking into the camera. If the pupils are dilated sufficiently, then red-eye will occur even if the subject is not looking directly into the camera.

Manual correction of red-eye problems in digital images can be time-consuming, as the user must identify the specific pixels to be corrected and then adjust the color data of these pixels until the desired color is achieved. Accordingly, automatic methods of correcting red-eye defects have been developed. However, these automatic methods suffer from defects themselves.

That is, scanning an entire digital photograph for red-eye defects can be time-consuming and may demand considerable processing power. Further, problems arise both from false positives and false negatives-false positives when the automatic method erroneously identifies objects in the digital photograph as red-eye, and false negatives when the automatic method fails to locate actual instances of red-eye.

### SUMMARY OF THE INVENTION

In accordance with a first aspect of the invention, there is provided a method of correcting a red-eye effect in a digital image provided by a cluster of pixels. The method comprises (a) conducting at least one tophat operation over each pixel in the digital image to provide a tophat image; (b) conducting an intensity threshold operation on the tophat image to provide a segmentation mask for segmenting objects in the digital image; (c) for each segmented object in the segmentation mask, extracting at least one feature from at least one of the segmented object and a border region surrounding the segmented object and classifying the segmented object based on the at least one feature; and (d) for each segmented object in the segmentation mask classified as red-eye effect in step (c), correcting the red-eye effect by re-coloring the segmented object to generate a corrected image.

In accordance with a second aspect of the invention, there is provided a system for correcting a red-eye effect in a digital image provided by a cluster of high intensity pixels. The system comprises a memory for storing the digital image; and means for performing the steps of (a) conducting at least one tophat operation over each pixel in the digital image to provide a tophat image; (b) conducting an intensity threshold operation on the tophat image to provide a segmentation mask for segmenting objects in the digital image; (c) for each segmented object in the segmentation mask, extracting at least one feature from at least one of the segmented object and a border region surrounding the segmented object and classifying the segmented object based on the at least one feature; and (d) for each segmented object in the segmentation mask classified as red-eye effect in step (c), correcting the red-eye effect by re-coloring the segmented object to generate a corrected image.

In accordance with a third aspect of the invention, there is provided a computer program product for use on a computer system to correct a red-eye effect in a digital image defined over a cluster of pixels. The computer program product comprises a recording medium and means recorded on the medium for instructing the computer system to perform the steps of (a) conducting at least one tophat operation over each pixel in the digital image to provide a tophat image; (b) conducting an intensity threshold operation on the tophat image to provide a segmentation mask for segmenting objects in the digital image; (c) for each segmented object in the segmentation mask, extracting at least one feature from at least one of the segmented object and a border region surrounding the segmented object and classifying the segmented object based on the at least one feature; and (d) for each segmented object in the segmentation mask classified as red-eye effect in step (c), correcting the red-eye effect by re-coloring the segmented object to generate a corrected image.

### BRIEF DESCRIPTION OF THE DRAWINGS

A detailed description of preferred aspects is provided herein below with reference to the following drawings, in which

FIG. 1, in a flowchart, illustrates an automatic method for detecting and removing red-eye defects in accordance with a preferred aspect of the invention;

FIG. 2a illustrates a large red-eye at full resolution;

FIG. 2b illustrates a large red-eye at half resolution;

FIG. 2c illustrates a large red-eye at quarter resolution;

FIG. 2d illustrates a medium red-eye at full resolution;

FIG. 2e illustrates a medium red-eye at half resolution;

FIG. 2f illustrates a medium red-eye at quarter resolution;

FIG. 2g illustrates a small red-eye at full resolution;

FIG. 2h illustrates a small red-eye at half resolution;

FIG. 2i illustrates a small red-eye at quarter resolution;

FIG. 3a illustrates an original image of a baby having red-eye;

FIG. 3b illustrates a segmentation mask derived from the image of FIG. 3a;

FIG. 3c illustrates a red-eye mask derived from the segmentation mask of FIG. 3b;

FIG. 4 illustrates an image having a sub-image drawn around a red-eye defect;

FIG. 5, in accordance with a further preferred embodiment of the invention, illustrates a method of locating and correcting the red-eye defect in the sub-image of FIG. 4;

FIG. 6a illustrates an original object in a pixel grid;

FIG. 6b illustrates the object of FIG. 6a after dilation;

FIG. 6c illustrates the object of FIG. 6a after erosion;

FIG. 6d illustrates a border region of the object of FIG. 6a derived from the dilated object of FIG. 6b and the eroded object of FIG. 6c; and,

FIG. 7, in a block diagram, illustrates a computer system for configuring to implement an embodiment of the invention.

### DETAILED DESCRIPTION OF PREFERRED ASPECTS

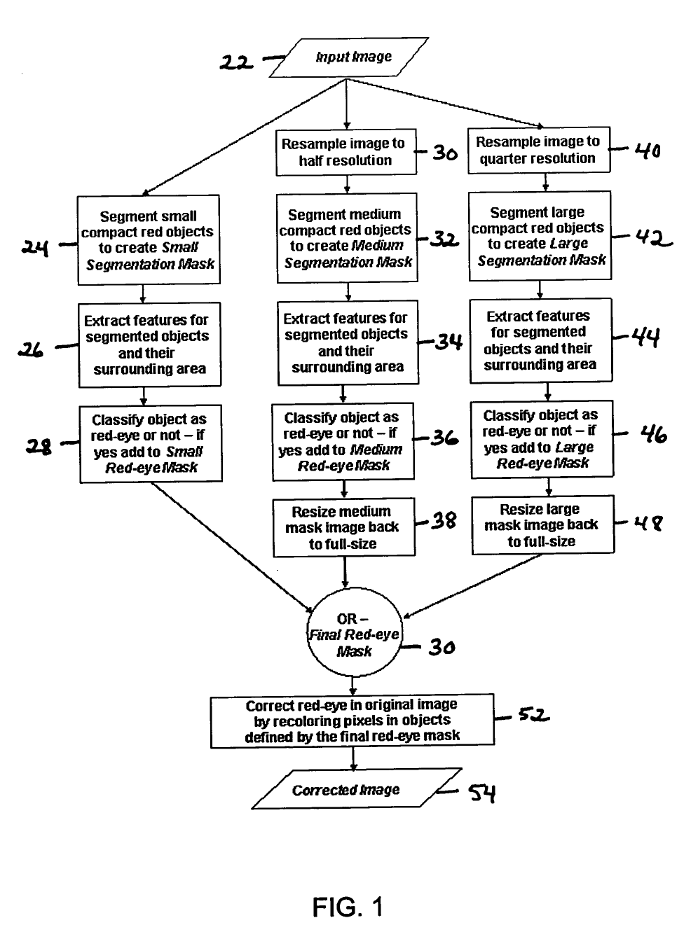

Referring to FIG. 1, there is illustrated in a flowchart an automatic method for detecting and removing red-eye defects in digital photographic images. In step 22, the digital photograph image is provided. In step 24, a full resolution version of this digital image is analyzed to segment small compact red objects within the digital image. A color image can be split into three greyscale images where each image contains one of the red, green or blue component intensities of that image. Segmentation is performed using at least one tophat operation performed on an image. The image to be segmented may be the red component image. Alternatively, a red-intensified image may be generated for segmentation, for example, by subtracting the green component image from the red component image. Another alternative for segmentation is an inverted red-intensified image in which red areas are relatively dark, which can be produced, for example, by subtracting-the red component image from the green component image. A bright tophat operation (h_{b}) that can be used to segment high intensity regions is defined as follows (“Digital Image Processing” by Rafael C. Gonzalez and Richard E. Woods, Addison Wesley Publishing, 1992 edition):

h_{b}=f−((f√g)-g)

where: f is the input image, g is a structuring element (a structuring element used is a 3×3 pixel square), √ indicates one or more grayscale image erosions, and - indicates one or more grayscale image dilations.

Similarly, a dark top hat operation (hd) that can be used to segment low intensity regions is defined as follows:

h_{d}=((f-g)√g)−f

where: f is the input image, g is a structuring element (a structuring element used is a 3×3 pixel square), √ indicates one or more grayscale image erosions, and - indicates one or more grayscale image dilations.

A greyscale erosion is an operation performed on a greyscale image. A greyscale erosion replaces each pixel intensity with the minimum intensity of the pixel and its surrounding pixels in the original image.

For example:

the original image:

$$5 \; 4 \; 3 \; 5 \; 5 \; 2 \; 1 \; 6$$

$$3 \; 6 \; 5 \; 9 \; 8 \; 7 \; 7 \; 2$$

$$3 \; 4 \; 1 \; 4 \; 9 \; 9 \; 8 \; 9$$

$$9 \; 9 \; 8 \; 8 \; 7 \; 2 \; 3 \; 5$$

becomes:

$$3 \; 3 \; 3 \; 3 \; 2 \; 1 \; 1 \; 1$$

$$3 \; 1 \; 1 \; 1 \; 2 \; 1 \; 1 \; 1$$

$$3 \; 1 \; 1 \; 1 \; 2 \; 2 \; 2 \; 2$$

$$3 \; 1 \; 1 \; 1 \; 2 \; 2 \; 2 \; 3$$

As described above, each of the numbers in this image could vary between 0 and 255 inclusive—the numbers are restricted to those-between 1 and 9 inclusive for ease of representation.

A greyscale dilation replaces each pixel intensity with the maximum intensity of the pixel and its surrounding pixels in the original image. For example,

the eroded image:

$$3 \; 3 \; 3 \; 3 \; 2 \; 1 \; 1 \; 1$$

$$3 \; 1 \; 1 \; 1 \; 2 \; 1 \; 1 \; 1$$

$$3 \; 1 \; 1 \; 1 \; 2 \; 2 \; 2 \; 2$$

$$3 \; 1 \; 1 \; 1 \; 2 \; 2 \; 2 \; 3$$

becomes:

$$3 \; 3 \; 3 \; 3 \; 3 \; 2 \; 1 \; 1$$

$$3 \; 3 \; 3 \; 3 \; 3 \; 2 \; 2 \; 2$$

$$3 \; 3 \; 1 \; 2 \; 2 \; 2 \; 3 \; 3$$

$$3 \; 3 \; 1 \; 2 \; 2 \; 2 \; 3 \; 3$$

Bright regions in either the bright or the dark tophat image will correspond to concentrations of red in the original image. As described above, the bright tophat operation involves first an erosion and then a dilation. Specifically, in an erosion operation, the intensity value for each pixel is changed to equal the minimum intensity value in the 8 pixels surrounding that pixel and that pixel itself. Thus, by each erosion operation, the borders of a pixel cluster of bright intensity will creep inwards. If the object provided by the pixels of bright intensity is sufficiently small, or sufficient erosion operations are performed, then this region of bright intensity will be eliminated. After the erosion operation, a dilation operation is performed. This dilation operation is the reverse of the erosion operation. That is, for each pixel to which the dilation operation is applied, the intensity value for that pixel will be replaced with the maximum intensity value for each of the 8 pixels surrounding that pixel and that pixel itself. Thus, if any of the original region of high intensity to which the erosion operation was applied remains, then the dilation operation will result in the borders of this high intensity object expanding outwards once again. However, if this high intensity object has been completely eliminated by the erosion operation, then the dilation operation will not bring it back.

As shown in the above bright tophat equation, after equal numbers of erosion and dilation operations have been applied to the original image, the intensity values for this eroded and dilated image are subtracted from the corresponding intensity values for the original image, producing a tophat image in which bright regions correspond to concentrations of red in the original image.

Similarly, a dark tophat operation could be performed on an inverted red-intensified image in which red areas are relatively dark. As shown in the above dark tophat equation, after equal numbers of dilation and erosion operations have been applied to the original image, the intensity values for the original image are subtracted from the corresponding intensity values for the dilated and eroded image, producing a tophat image in which bright regions correspond to concentrations of red in the original image.

The tophat image is intensity thresholded such that bright regions become objects of interest. Of these objects, only objects with compactness less than a compactness threshold are retained as objects of interest. Compactness can be defined as follows:

compactness=object perimeter/(4×π×object area)

In this equation, both the object perimeter and area are measured in pixels.

By this means, elongated patches of redness are removed to produce a small segmentation mask. In this small segmentation mask, the locations and shapes of the segmented objects are represented by white pixels and all other pixels are black. The single segmented object is defined as a collection of white pixels connected to each other vertically, horizontally or diagonally.

In step 26, features are extracted from the digital image for each object in the small segmentation mask. The features extracted may include the original color of each segmented object, its segmented shape, and its original color texture as well as the original color and texture of the region surrounding the object. For example, color features abstracted might include the mean red intensity of the object, the maximum red intensity within the object, and the mean green intensity of the object. Shape features might include perimeter and compactness. A number of texture features are calculated by measuring the pixel intensities in the object after an edge filter has been used on the image.

In step 28, each segmented object is classified based on the feature set abstracted in step 26. That is, each segmented object is classified based on the probability that the object is a red-eye defect. According to an aspect of the present invention, the probability that an object is a red-eye defect can be determined by calculating the degree of similarity to a red-eye paradigm cluster. For example, this probability can be determined by calculating the object's quadratic classifier distance to a training red-eye feature cluster. The equation for the quadratic classifier distance (Q) is as follows:

Q=Features * A * Features′+b * Features+c

where:

Features=the feature vector-describing the object to be classified

Features′=the transpose of the feature vector

A=inv(K_non)−inv(K_defect)

K_non=covariance matrix of the non defect training class

K_defect=covariance matrix of the defect training class

b=2* inv(K_defect)* m_defect−inv(K_non)* m_non

m_non=mean of the non defect class

m_defect=mean of the defect class

c=m_non * inv(K_non)* m_non′−m_defect * inv(K_defect)* m_defect′

The probability that an object is a red-eye defect is proportional to Q is calculated using the above function. If the probability is higher than a selected threshold, then the object is classified as a red-eye defect, while if the probability is lower than the given threshold, the object is classified as not a red-eye defect. The threshold is set at a level that produces an acceptable compromise between false positives and false negatives. That is, the threshold is set at a level that enables an acceptably high proportion of red-eye defects to be detected, while minimizing the number of objects that are erroneously identified as red-eye defects. This classification process produces a small red-eye mask.

Preferably, multiple resolutions of the digital photograph image are used for speed optimization as full resolution is not required for the detection of medium and large red-eye objects. There is no limit on the number of resolutions that can be used. In a preferred aspect of the invention illustrated in FIG. 1, three resolutions are used: full resolution, half resolution and quarter resolution. For example, a 4000×4000 pixel image will be analyzed at full resolution (4000×4000), at half resolution (2000×2000) and at quarter resolution (1000×1000). These three resolutions are indicated in FIG. 1 by the three separate paths of the flowchart that originate from step 22.

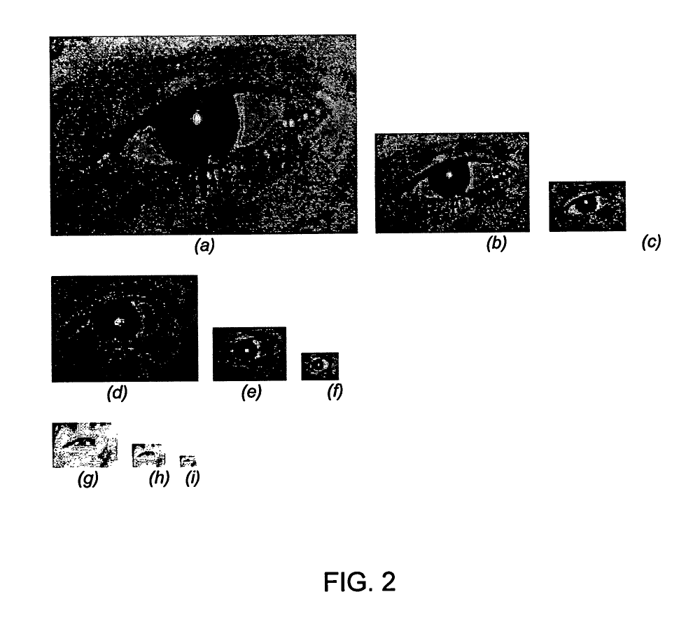

As shown in FIG. 1, the initial image provided in step 22 is re-sampled in steps 30 and 40 to provide a half resolution image and a quarter resolution image respectively. Referring to FIG. 2, there are illustrated various sizes of red-eye at different resolutions. For example, in FIG. 2a a large red-eye is shown at full resolution, in FIG. 2b a large red-eye is shown at half resolution, and in FIG. 2c a large red-eye is shown at quarter resolution. In FIG. 2d, a medium red-eye is shown at full resolution, in FIG. 2e a medium red-eye is shown at half resolution, and in FIG. 2f a medium red-eye is shown at quarter resolution. In FIG. 2g, a small red-eye is shown at full resolution, in FIG. 2h, a small red-eye is shown at half resolution, and in FIG. 2i, a small red-eye is shown at quarter resolution.

A number of advantages flow from conducting the above analysis on images at different resolutions. Specifically, for red-eye defects above a certain size, such defects can be most efficiently found through analysis of a quarter resolution image, rather than a half resolution image or a full resolution image, as (1) sufficient pixels showing the red-eye defect are present, and (2) fewer pixels need be considered in order to find the red-eye defect. On the other hand, for small red-eyes, information may be lost in the lower resolution images that is required to identify the object as a red-eye defect at the required level of probability. In such cases, the full resolution image may provide the additional information required to classify the object as either a red-eye defect or as not being a red-eye defect.

Analogous to step 24 described above, in steps 32 and 42 the half resolution image and quarter resolution image respectively are analyzed. In the case of step 32, medium compact red objects in the half resolution digital image are segmented to create a medium segmentation mask. In step 42, large compact red objects in the quarter resolution digital image are segmented to create the large segmentation mask.

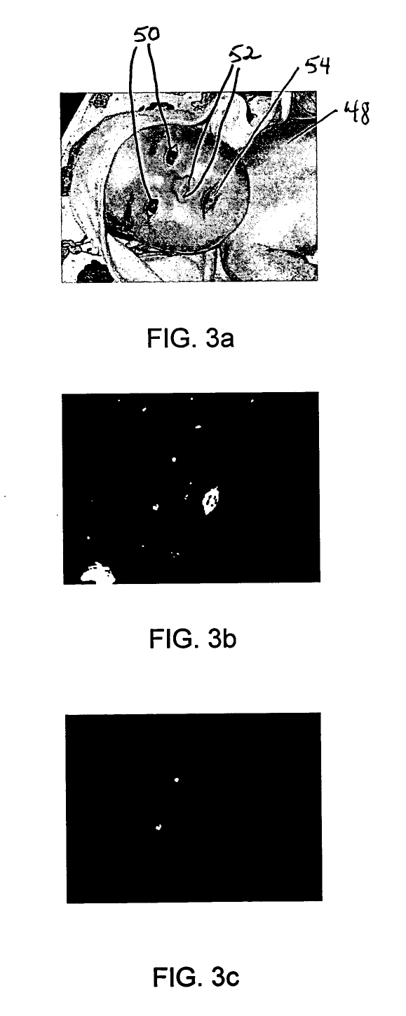

Optionally, at this point, the three segmentation masks created in steps 24, 32 and 42 can be combined such that each object segmented in one of these segmentation masks appears in the combined segmentation mask. Referring to FIG. 3, this process is illustrated in an original image, as well as in a combined segmentation mask and in a final red-eye mask derived from the original image. That is, a small segmentation mask, medium segmentation mask and large segmentation mask are created in steps analogous to steps 24, 32 and 42 respectively described above. Then, unlike the method illustrated in FIG. 1, these three segmentation masks are combined to provide the combined segmentation masks shown in FIG. 3b. As shown, areas of high intensity redness in the original image, such as the red-eyes 50 of the baby 48, the nostrils 52 of the baby 48 and the lips 54 of the baby 48 appear as areas of white intensity in the surrounding black of the combined segmentation mask of FIG. 3b. Then, analogous to step 26 of FIG. 1 described above, features are abstracted from the segmented objects as well as their surrounding areas, and the objects identified in the combined segmentation masks of FIG. 3b are classified as red-eye defects or as not being red-eye defects in a step analogous to step 28, thereby providing the final red-eye mask shown in FIG. 3c. In FIG. 3c, the lips, nostrils and other objects shown in the combined segmentation mask have been discarded as they do not meet a selected threshold probability of being instances of red-eye, such that the only white areas remaining correspond to the red-eyes 50a of the baby 48.

The flowchart of FIG. 1 does not illustrate this method of FIG. 3. Instead, the feature abstraction steps and classification steps are separately executed with respect to each segmentation mask. Specifically, in step 34, analogous to step 36, features are abstracted from the segmented objects in the medium segmentation mask provided in step 32. Similarly, in step 44, features are abstracted from the objects segmented and their surrounding areas in the large segmentation mask created in step 42. Then, in steps 36 and 46 respectively, objects segmented in the medium segmentation mask and large segmentation mask respectively are classified as red-eye if they meet the threshold probability—that is, if each object's quadratic classifier distance is sufficiently small to meet the probability threshold selected.

In steps 38 and 48, the medium red-eye mask provided in step 36 and the large red-eye mask provided in step 46 respectively are resized to full resolution. Then, in step 50, the red-eye masks provided by steps 28, 38 and 48 are disjunctively combined to yield a final red-eye mask having each red-eye object in each of the red-eye masks. In step 52, objects classified as red-eye are re-colored to produce a corrected image. That is, an object classified as red-eye is re-colored to remove its red appearance. In a first stage, the object classified as red-eye is re-colored in the original image so that each pixel within the object is provided with new color values based on the color of the corresponding pixel in the original image. For example, the new red color could be set to equal the average of the original green color value and the original blue color value. The new green color value could be set to equal the new red color value minus 10. (to a minimum of 0). The new blue color value could be set to equal the new red color value minus 20 (to a minimum of 0). By following the above steps, a stage one re-colored image is provided. Recall that the color values will range from 0 to 255.

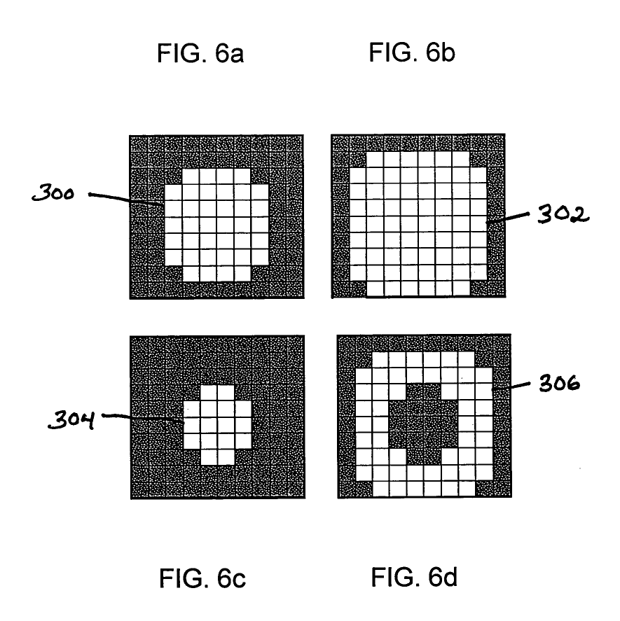

If the object is larger than an area threshold (such as, for example, an area threshold of 35 pixels), then the border of the object may be smoothed with the surroundings so that it appears more natural. These steps are illustrated in FIG. 6.

An original object 300 is shown in FIG. 6a. This original object 300 is dilated as described above to yield the dilated object 302 shown in 6b. This original object 300 is also eroded, as described above, to yield an eroded object 304 shown in FIG. 6c. This eroded object 304 is then subtracted from the dilated object 302 of FIG. 6b to yield a border region 306 shown in FIG. 6d.

The stage one re-colored image described above is then smoothed by convolving the image with a smoothing filter. For example, a possible smoothing filter is:

$$\begin{matrix}1 & 2 & 1 \\ 2 & 4 & 2 \\ 1 & 2 & 1\end{matrix} \div 16$$

Applying this filter produces an image designated the smoothed stage one re-colored image. The smooth stage one re-colored image pixels that are in the border region 306 are subsequently used to replace the corresponding pixels in the stage one re-colored image to produce the final re-colored image.

Semi-Automated Operation

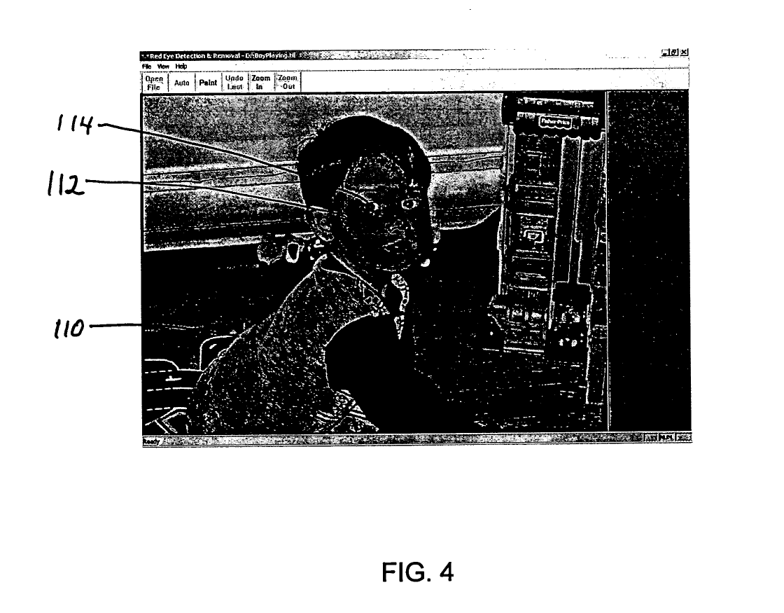

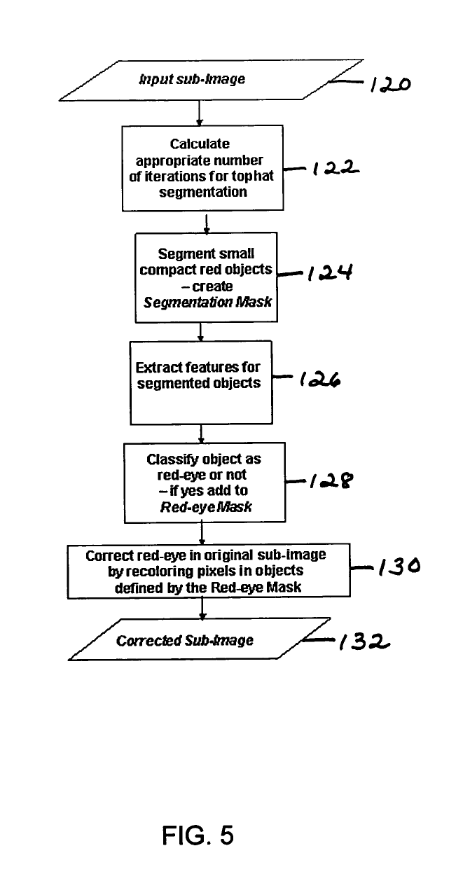

Referring to FIG. 5, there is illustrated in a flowchart a method for the semi-automated detection and removal of red-eye in digital photographic images in accordance with a further aspect of the invention. This function is typically defined to operate on a sub-image of a larger image. The size of the sub-image for this function should be larger than the maximum height and maximum width of the red portion of the eye. Referring to FIG. 4, there is illustrated an image of a child 110, in which a sub-image 112 is indicated as a grey box surrounding the child's eye 114.

Referring back to FIG. 5, in step 120, a sub-image 112 is provided. This may be provided by a user tracing a box around the portion of the image to be analyzed. In step 122, the appropriate number of erosions and dilations to use for the tophat operation during segmentation is calculated. The number of erosions and dilations is proportional to the size of the sub-image 112. As described above, the size of the sub-image 112 should be larger by some multiple than the maximum height and maximum width of the red-eye portion of the eye 114. This multiple can range from a lower limit to an upper limit. In step 122, the average of the width and the average of the height of the sub-image 112 are added. This sum is then divided by the upper limit and then divided by 2 and rounded to the nearest integer. This represents the lowest number of erosion and dilation operations. The sum is then divided by the lower limit and then divided by 2 and rounded to the nearest integer. This represents the highest number of erosion and dilation operations. Then, a number of tophat operations are performed in step 124. The number of erosions and dilations used for each tophat operation ranges from the lowest number to the highest number. Similar to step 24 described above, small compact red objects are segmented in step 124 by performing at least one tophat operation as described above. This produces a segmentation mask where the locations and shapes of the segmented objects are represented by white pixels and all other pixels are black.

In step 126, and analogous to step 26 described above, features of segmented objects are extracted for the objects in the segmentation block. For example, in step 128, analogous to step 28, each segmented object is classified based on the feature set extracted for that object in step 126. Again, as described above, the classification technique used is based on the object's quadratic classifier distance. If the quadratic classifier distance is greater than a given threshold, then the object is classified as red-eye. If the quadratic classifier distance is less than a given threshold, then the object is classified as a non-red-eye. By this means, a red-eye mask is produced in step 128. In step 130, analogous to step 52 described above, the areas classified as red-eye are re-colored using greyscale to produce the corrected image. This coloration may be the same as described above in connection with step 52. Alternatively, the greyscale values used may be equal to the average of the actual green and blue pixels in the original image. The features extracted describe each segmented object's original color, segmented shape and original color texture.

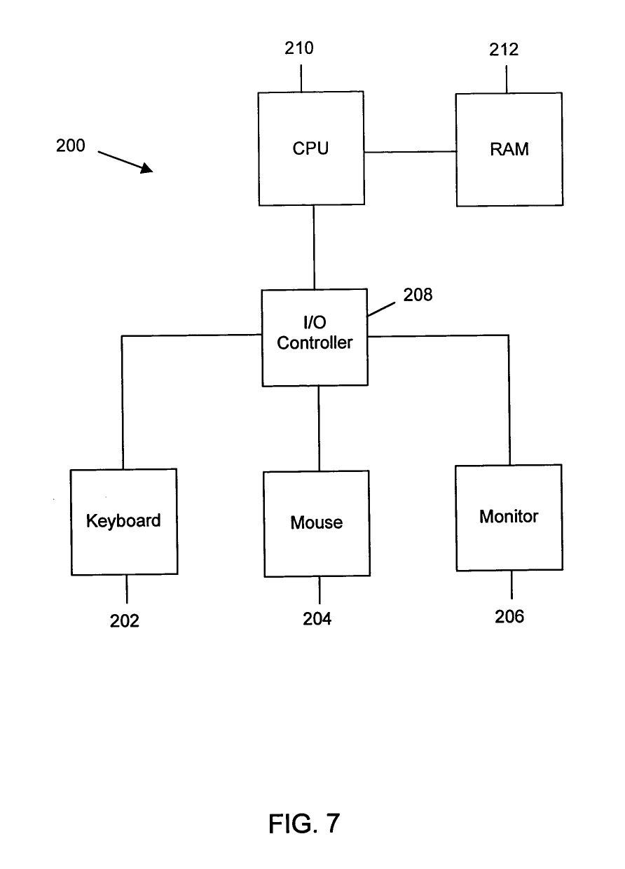

Referring to FIG. 7, there is illustrated in a block diagram, a computer system suitable for implementing an embodiment of the present invention. Specifically, the computer system comprises a CPU 210 connected to a RAM 212. The CPU 210 is also connected to an input/output controller 208, which controls access to a keyboard 202, mouse 204 and monitor 206.

In accordance with an aspect of the invention, the CPU 210 is configured to implement a preferred embodiment of the invention. In this case, a digital photograph image would be stored in RAM 212, and, optionally, displayed on monitor 206. Then, the CPU 210 would perform steps on the digital photographic image, analogous to the steps described in relation to FIG. 1, to locate and correct red-eye. Alternatively, a user could use mouse 204 to draw a box around a sub-image including instances of what is believed to be red-eye. Then, the CPU 210 could implement the method described in connection with FIG. 5.

Decrease Sensitivity Operation

After automated correction of red-eye objects, the corrected image is shown on the monitor 206. At that point, a user may decide that some objects have been erroneously identified as red-eye and re-colored. For example, a red Christmas tree light may accidentally have been re-colored. In general, a false positive object is a single object in one of the red-eye masks that does not correspond to an actual red-eye.

Using a suitable input device, such as the keyboard 202 or mouse 204, the user can then trigger a decrease sensitivity operation. The red-eye mask images generated by the CPU 210 are retained in RAM 212 until, at least, the next time an image is corrected. Also retained in RAM 212 is the probability that each segmented object in the digital image displayed is red-eye. When the decrease sensitivity operation is triggered by the user, of all of the objects classified as red-eye from all of the segmentation masks, a specified number of objects with the lowest probability of being red-eye will be classified as non-red-eye, removed from the appropriate red-eye mask image and returned to their original color in the corrected image shown in the monitor 206. Optionally, a user may change the specified number of objects, such that the number of objects reclassified from being red-eye to being not red-eye changes. Alternatively, a user may simply change the threshold for the probability that an image is red-eye by raising the threshold, such that fewer objects will be classified as red-eye. According to a further aspect of the invention, the user identifies a particular object identified as red-eye, which the user believes is not red-eye. The CPU 210 will then raise the probability threshold required to classify an object as red-eye by an amount sufficient to declassify the object selected as red-eye, as well as any other objects having the same or lower probability of being red-eye.

Increase Sensitivity Operation

When a corrected image is displayed in the monitor 206, a user may see an instance of red-eye that was not corrected. As described above in relation to the decrease sensitivity operation, segmentation masks images generated by the CPU 210 are retained in RAM 212 as is the probability that each object in the segmentation mask images is a red-eye. When the increase sensitivity operation is called by a user, of all of the objects in all of the segmentation masks that have not already been classified as red-eye, a specified number of objects with the highest probability of being a red-eye will be classified as red-eye and added to the appropriate red-eye mask. The new corrected image will then include all of the red-eyes added by the increase sensitivity operation as well as all of those originally classified as red-eyes. All newly classified instances of red-eye will be re-colored as described above. Optionally, a user may select the number of objects to be re-classified. Alternatively, the user may directly lower the threshold probability required for an object to be classified as red-eye, or may pick out a particular instance of an object that, in the user's view, should have been classified as red-eye, but was not in the original corrected image, and then lower the threshold probability for an object to be identified as red-eye to a sufficient extent to enable the object selected to be identified as red-eye.

Manual Override Operation

A user viewing a corrected image in the monitor 206 may see a red-eye that was not detected, or an object that has been incorrectly classified as red-eye and re-colored. Further, it may not be possible to correct this problem using either the decrease sensitivity operation or the increase sensitivity operation as doing so would create additional false negatives or false positives. In this case, the user may indicate the pixels of either the undetected red-eye or the false positive object using the mouse 204, say, and then call the manual override operation.

When the manual override operation is called, it determines if the coordinates identified by the user are located on an object currently classified as red-eye. If so, then the user considers this to be a false positive, and the operation will remove the object from the appropriate red-eye masks and set the probability that the segmented object is a red-eye to a lower value than the probability for any other segmented object in the entire image. This indicates for the purposes of any further operations that this object is unlikely to be a red-eye. Finally, the object is returned to its original color in the corrected image.

If the coordinates indicated by the user are located on an object currently classified as not red-eye, indicating that the user considers this object to be an undetected red-eye, then each segmentation mask is checked to determine if the coordinates are located on a segmented object that is present in the mask. If so, then that object will be classified as red-eye and added to the appropriate red-eye mask. The probability that the segmented object is a red-eye is then set to a higher value than the probability for any other segmented object in the entire image. This indicates for the purposes of any further operations that the object is highly likely to be red-eye. Finally, the object is re-colored in the corrected image as described above.

Other variations and modifications of the invention are possible. For example, while the foregoing has been described in the context of a red-green-blue pixel coloring system, other color systems could be used, such as, for example, a cyan-magenta-yellow-key system or a hue-saturation-value system, which similarly represent colors as combinations of their respective color components. All such modifications or variations are believed to be within the sphere and scope of the invention as defined by the claims appended hereto.

1. A method of correcting a red-eye effect in a digital image provided by a cluster of pixels, the method comprising:
(a) conducting at least one tophat operation over each pixel in the digital image to provide a tophat image;
(b) conducting an intensity threshold operation on the tophat image to provide a segmentation mask for segmenting objects in the digital image;
(c) for each segmented object in the segmentation mask, extracting at least one feature from at least one of the segmented object and a border region surrounding the segmented object and classifying the segmented object based on the at least one feature; and
(d) for each segmented object in the segmentation mask classified as red-eye effect in step (c), correcting the red-eye effect by re-coloring the segmented object to generate a corrected image.

2. The method as defined in claim 1 wherein the tophat image is a dark tophat image, and the tophat operation comprises the steps of:
conducting at least one greyscale dilation operation over each pixel in the digital image to provide a dilated image;
conducting at least one greyscale erosion operation over each pixel in the eroded image to provide an eroded image; and, subtracting the digital image from the eroded image to provide the dark tophat image.

3. The method as defined in claim 1 wherein the tophat image is a bright tophat image, and the tophat operation comprises the steps of:
conducting at least one greyscale erosion operation over each pixel in the digital image to provide an eroded image;
conducting at least one greyscale dilation operation over each pixel in the eroded image to provide a dilated image; and, subtracting the dilated image from the digital image to provide the bright tophat image.

4. The method as defined in claim 1 further-comprising generating at least one low resolution image from the digital image;
conducting a secondary tophat operation over each pixel in the at least one low resolution image to provide at least one low resolution tophat image;
conducting an intensity threshold operation on the at least one low resolution tophat image to provide at least one low resolution segmentation mask for segmenting objects in the digital image;
for each segmented object in the at least one low resolution segmentation mask, extracting at least one feature from one of the segmented object and a border region surrounding the segmented object and classifying the segmented object based on the at least one feature; and
for each segmented object in the at least one low resolution segmentation mask classified as red-eye effect in step (c), correcting the red-eye effect by re-coloring the segmented object.

5. The method as defined in claim 1 wherein step (b) comprises, after intensity thresholding the bright tophat image, filtering out objects having a compactness below a threshold level of compactness to provide the segmentation mask.

6. The method as defined in claim 1 wherein step (c) comprises, for each segmented object in the segmentation mask, after extracting the at least one feature, comparing the at least one feature with a paradigmatic red-eye feature cluster to determine an associated probability that the segmented object is a red-eye defect, and classifying the segmented object as a red-eye defect if and only if the associated probability exceeds a threshold probability.

7. The method as defined in claim 1 further comprising selecting the digital image from an initial image.

8. A system for correcting a red-eye effect in a digital image provided by a cluster of high intensity pixels, the system comprising:
a memory for storing the digital image; and
means for performing the steps of
(a) conducting at least one tophat operation over each pixel in the digital image to provide a tophat image;
(b) conducting an intensity threshold operation on the tophat image to provide a segmentation mask for segmenting objects in the digital image;
(c) for each segmented object in the segmentation mask, extracting at least one feature from at least one of the segmented object and a border region surrounding the segmented object and classifying the segmented object based on the at least one feature; and
(d) for each segmented object in the segmentation mask classified as red-eye effect in step (c), correcting the red-eye effect by re-coloring the segmented object to generate a corrected image.

9. The system as defined in claim 8 wherein the tophat image is a dark tophat image, and the tophat operation comprises the steps of:
conducting at least one greyscale dilation operation over each pixel in the digital image to provide an dilated image;
conducting at least one greyscale erosion operation over each pixel in the eroded image to provide a eroded image;
subtracting the digital image from the eroded image to provide the dark tophat image.

10. The system as defined in claim 8 wherein the tophat image is a bright tophat image, and the tophat operation comprises the steps of:
conducting at least one greyscale erosion operation over each pixel in the digital image to provide an eroded image;
conducting at least one greyscale dilation operation over each pixel in the eroded image to provide a dilated image; and, subtracting the dilated image from the digital image to provide the bright tophat image.

11. The system as defined in claim 8 further comprising means for generating at least one low resolution image from the digital image.

12. The system as defined in claim 8 wherein step (b) comprises, after intensity thresholding the bright tophat image filtering out objects having a compactness below a threshold level of compactness stored in the memory to provide the segmentation mask.

13. The system as defined in claim 8 wherein step (c) comprises, for each segmented object in the segmentation mask, after extracting the at least one feature, comparing the at least one feature with a paradigmatic red-eye feature cluster stored in the memory to determine an associated probability that the segmented object is a red-eye defect, and classifying the segmented object as a red-eye defect if and only if the associated probability exceeds a threshold probability.

14. The system as defined in claim 8 further comprising
a display for displaying n initial image; and
a user-operable selection means for selecting the digital image from the large image.

15. The system as defined in claim 13 further comprising a user-operable selection means for selectably changing the threshold probability.

16. The system as defined in claim 8.further comprising
a display for displaying the corrected image;
a user-operable selection means for selecting an object in the corrected image to generate a corrected image; and,
a user-selectable manual override operation for (i) when the object has been classified as red-eye, uncoloring and reclassifying the object and (ii) when the object has not been classified as red-eye, reclassifying the object as red-eye and recoloring the object to correct for the red-eye effect.

17. A computer program product for use on a computer system to correct a red-eye effect in a digital image defined over a cluster of pixels, the computer program product comprising:
a recording medium;
means recorded on the medium for instructing the computer system to perform the steps of:
(a) conducting at least one tophat operation over each pixel in the digital image to provide a tophat image;
(b) conducting an intensity threshold operation on the tophat image to provide a segmentation mask for segmenting objects in the digital image;
(c) for each segmented object in the segmentation mask, extracting at least one feature from at least one of the segmented object and a border region surrounding the segmented object and classifying the segmented object-based on the at least one feature; and
(d) for each segmented object in the segmentation mask classified as red-eye effect in step (c), correcting the red-eye effect by re-coloring the segmented object to generate a corrected image.

18. The computer program product as defined in claim 17 wherein the tophat image is a dark tophat image, and the tophat operation comprises the steps of:
conducting at least one greyscale dilation operation over each pixel in the digital image to provide an dilated image;
conducting at least one greyscale erosion operation over each pixel in the eroded image to provide a eroded image;
subtracting the digital image from the eroded image to provide the dark tophat image.

19. The computer program product as defined in claim 17 wherein the tophat image is a bright tophat image, and the tophat operation comprises the steps of:
conducting at least one greyscale erosion operation over each pixel in the digital image to provide an eroded image;
conducting at least one greyscale dilation operation over each pixel in the eroded image to provide a dilated image; and,
subtracting the dilated image from the digital image to provide the bright tophat image.

20. The computer program product as defined in claim 17 wherein step (b) comprises, after intensity thresholding the bright tophat image filtering out objects having a compactness below a threshold level of compactness stored in the memory to provide the segmentation mask.
